(19) United States
(12) Patent Application Publication
(10) Pub. No.: US 2008/0027862 A1
(43) Pub. Date: Jan. 31, 2008

(54) Novel hybrid financial interface

(76) Inventor: Michelle E. Daly-DeSchryver, Rocklin, CA (US)

Correspondence Address: Andy Youngs, PO Box 7179, Citrus Heights, CA, 95621, US

(21) Appl. No.: 11/825,426

(22) Filed: Jul. 6, 2007

Related U.S. Application Data
(60) Provisional application No. 60/820,263, filed on Jul. 25, 2006.
(60) Provisional application No. 60/878,308, filed on Jan. 2, 2007.
(60) Provisional application No. 60/907,369, filed on Mar. 29, 2007.

(51) Int. Cl. G06Q 40/00; A63F 13/08

(52) U.S. Cl. 705/43

(57) ABSTRACT

Methods and equipment for the receiving of coins, currency and other forms of monetary value have been in use for decades, and take many forms. Generally the system exchanges one form of value, such as coins, currency or electronic funds from credit or debit cards, for another form of value, such as a video game, candy bar, receipt for cash, etc. In addition to the exchange of value, many systems, such as automatic teller machines (ATMs) also allow the user to perform other services, such as transferring money from one account to the other.

The interface between the user and the exchange system is the most significant difference between these systems. This invention teaches and claims a novel interface designed to provide younger users (children and teenagers) with the opportunity to participate in financial savings and transfer transactions that for user-operated systems were typically limited to adults.

The interface comprises a series of graphical constructs which would appeal to children and provide an entertainment experience for the user while performing financial transactions. This interface can take the form of, but is not limited to, video games, visual exposure of internal workings of coin collection and interactive financial tutorials.

A further feature of this invention is the use of pneumatic transfer and hybrid energy technology to provide an improved interface to the owner of the system, such as a bank or store. An additional feature of this invention is the use of the child-friendly interface to provide ability to open and fund 529 College Savings Accounts.

### RELATED U.S. APPLICATION DATA

This application is a continuation of DeSchryver application US2007/0011089 A1 filed Jul. 9, 2005 and DeSchryver provisional applications U.S. 60/820,263 filed Jul. 25, 2006; U.S. 60/878,308 filed Jan. 2, 2007; and U.S. 60/907,369 filed Mar. 27, 2007, the contents of the specifications of which are incorporated into this specification by reference.

### BACKGROUND OF THE INVENTION

This invention includes details from previous patent applications filed by Michelle Daly-DeSchryver, including US2007/0011089 A1 filed Jul. 9, 2005 and provisional applications U.S. 60/820,263 filed Jul. 25, 2006; U.S. 60/878,308 filed Jan. 2, 2007; and U.S. 60/907,369 filed Mar. 27, 2007, the contents of the specifications of which are incorporated into this specification by reference. Also incorporated by reference is expired Deschryver provisional application “Biometric Self Service Kiosk with POS Integration” filed Mar. 15, 2006.

Methods and equipment for the receiving of coins, currency and other forms of monetary value have been in use for decades, and take many forms. Generally the system exchanges one form of value, such as coins, currency or electronic funds from credit or debit cards, for another form of value, such as a video game, candy bar, receipt for cash, etc.

The means of receipt of items of value and delivery of other items of value takes many forms, such as arcade video games, vending machines, coin redemption kiosks, etc. In addition to the exchange of value, many systems, such as automatic teller machines (ATMs) also allow the user to perform other services, such as transferring money from one account to the other.

A number of recent US patents and applications, such as U.S. Pat. No. 6,308,887 to Korman, et. al, US 2005/0086140 A1 to Ireland, et al, and US 2004/0124062 A1 to Molbak, teach and claim versions of coin counting equipment and kiosks and their functions. None of this art addresses the interface between the user and the kiosk, which is central to the invention of this application.

An embodiment of the current invention includes an interface designed to encourage children to utilize the hybrid financial kiosk to participate in 529 college savings plans as well as other forms of savings. In U.S. Pat. No. 5,252,811 Henochowitz, et al, teach and claim a method and device for increasing savings account participation by small investors. Though Henochowitz describes the use of a coin collection kiosk as part of his process, the process itself and interface is far too complex for use by children, and does not read on the current invention.

A further embodiment of the invention is the use of the hybrid financial kiosk to allow children to participate in 529 college savings program accounts. Molbak, et al, in U.S. Pat. No. 5,909,794 describes a system wherein a coin kiosk receives coins and transfers the value of said coins to a charity, providing the user with a receipt for the donation for tax purposes. This invention once again does not provide the simplicity and entertainment value needed to allow use by children, nor does it allow for the combined features of entertainment while transferring coinage and other assets into the 529 college savings fund which will grow to increased value for the child over the years.

A further embodiment of the invention is the use of pneumatic conveyance to transport the coins and currency received to a central vault or processing location. Though there are many forms of pneumatic conveyance in the prior art, applying this to a kiosk in order to reduce its size and footprint and therefore increase its value to the sore or bank using it is novel over the prior art.

A further embodiment of this invention is the use of hybrid energy technology to improve energy efficiency of the device. This could include solar power, lithium ion rechargeable batteries, and use of a user-operated mechanical generator in conjunction with storage batteries so the user generates the power necessary. Application of these hybrid sources to a financial interface and apparatus does not appear to exist in the public or patent literature.

The current invention comprises concepts, apparatus and methods which can produce better results than the current art available. The use of the invention by itself or in conjunction with any particular set of complimentary devices or techniques shall not be construed as a limitation.

### DESCRIPTION OF THE INVENTION

The invention of this application has many preferred embodiments, a number of which are detailed in the patent applications previously mentioned which are incorporated by reference. The general form of the invention is a self-service (user operated) child-friendly hybrid financial interface and/or kiosks which incorporate said interface and include pneumatic conveyance for deposited coins and currency and/or hybrid energy devices to conserve electrical energy usage.

User operated ATMs or coin kiosks are available in many forms, as are computer games, software for generating displays, games and managing financial on-screen transactions, and are readily applied by one skilled in the specific area such as coin kiosks, software, video games, etc.

The current invention provides an interface which is easily understood and operated by children. This interface is generated by utilizing displays and games which attract children and entertain them, while requiring input of value (hereinafter forms of value can be coins, currency, store scrip, debit cards, credit cards, electronic account transfers, etc., and the use of the descriptor of any one of these items, such as coins, also embodies all the other forms of value listed herein) which is retained by the child in the form of a savings account, 529 college savings program, store account balance or any other form of value which is not immediately tenderable but has future value.

The child-friendly feature of the interface may start with the exterior of the kiosk, which can have a unique shape which would attract children's attention, such as a rocket, slot machine, pinball machine or many other forms which are not normally used for financial kiosks. Another embodiment would include video games, the length of which the child could play being linked to the amount of money deposited. Thus the child is rewarded for putting more money into his or her savings account by getting more video game playing time at the kiosk.

The fact that amounts as small as a single penny can be deposited is an additional attraction to children. In one preferred embodiment, the system allows a parent to utilize the kiosk to link on-line to a site which allows them to open a 529 college savings program for the child, who then increases the value of that account every time he or she places money into the machine. The child receives the monetary value in the savings account plus the entertainment provided by the hybrid financial interface of the kiosk.

In one preferred embodiment, in addition to the child-friendly interface there would also be placed a screen and interface more suitable for adult use, which would be used for a variety of financial transactions, including opening of the 529 college savings accounts for their children. There would also in the programming of the child-friendly interface changes based on the age of the child as determined by a login and password.

The development of child-friendly games and activities which can be performed at the kiosk is easily accomplished by those skilled in the art of video game programming. The novelty of this invention comprises utilizing these games and activities as part of a hybrid financial interface which encourages children to invest and save money.

A further embodiment of this invention involves the use of pneumatic conveyance for financial kiosks as detailed in U.S. application 60/907,369, which this application is a continuation of. By utilizing pneumatic conveyance for transfer of coins and currency from the kiosk to a central vault or storage location, security of the machines is increased, but more importantly the need for storage space in the kiosk is eliminated and the size of the machine (often termed footprint) is reduced. This reduction in footprint provides increased value by utilizing less square footage of floor space, which can be very expensive.

A further embodiment of the invention is the incorporation of improved means of supplying the electrical energy to supply the power needed to operate the kiosk. Traditional means would require that electricity be run to the kiosk by means of a cord or hard-wiring. By providing hybrid energy sources, which could be high efficiency lithium ion rechargeable batteries, solar power, or hand-crank generators, the need for the kiosk to be near to electricity would be eliminated, and the environmental efficiency of the power system would appeal to the consumer.

A preferred embodiment would incorporate a generator driven by a hand crank or slot-machine lever that would send charge to a rechargeable lithium ion battery pack. By incorporating the generation of electricity into the operation of the kiosk and applying appropriate graphical representation of power generation on the kiosk screen, the generation of the power becomes part of the fun for the child and he or she can learn about energy efficiency and financial saving at the same time. The hand-crank generators are readily available and efficient, as evidenced by the ready availability of inexpensive hand-crank flashlights in today's market.

Another preferred embodiment of the current invention comprises the use of transparent covers for the kiosk and/or pneumatic tubing to allow the user to see how the internal portions of the machine, such as coin counting, sorting and conveyance, as well as power generation and electronic wiring. Such a transparent kiosk not only attracts children to it, it provides education on how the mechanical portions of the machine function and how the electronic portions of the machine look.

Embodiments of the current invention may include the electronic savings transfer (EST) prompt detailed in US2007/0011089 A1, which was incorporated by reference into this specification. Utilization of these prompts improves the ease of use of the hybrid financial interface for both adults and children.

Embodiments of the current invention may also include the use of connections from the kiosk interface to the internet, so that online transactions such as opening of savings accounts, downloading of advertisements and coupons from paid advertisers, etc. can be accomplished.

Due to the educational nature of the current invention, the placement of kiosks is not limited to the normal venues of banks and stores, but can be placed in schools, colleges, libraries, etc.

The composition of the preferred embodiments are by no means restrictive—there are numerous combinations of methods and apparatus which can achieve desired results, and the preferred embodiments as stated are not to be construed as restrictive of the invention.

I claim:

1) A hybrid financial interface comprising:
an apparatus equipped for the receipt of coins, currency and other forms of value;
a video screen;
software that provides games displayed on the video screen; and
means for allowing the user to play the games and access financial accounts in a single transaction.

2) The hybrid financial interface of claim 1, wherein:
the shape and appearance of the apparatus is that of a slot machine.

3) The hybrid financial interface of claim 1, wherein:
the coins and currency collected in the apparatus are conveyed pneumatically to a central vault or remote storage location.

4) The hybrid financial interface of claim 1, wherein:
the power for the apparatus is supplied by means of a portable storage device such as a lithium ion battery.

5) The hybrid interface of claim 1, wherein:
the power for the apparatus is supplied by means of a mechanical generator operated by the user.

6) The hybrid interface of claim 1, wherein:
the user can add value to a 529 college savings account while playing a game.

7) The hybrid interface of claim 1, wherein:
the appearance of the apparatus is that of an arcade video game machine

8) The hybrid interface of claim 1, including:
a separate screen which can be utilized by adults for financial transactions and setting up savings accounts for their children

9) The hybrid interface of claim 1, including:
a connection to the internet

10) The hybrid interface of claim 1, including:
means for opening and accessing preferred customer accounts

11) The hybrid interface of claim 1, wherein:
The case of the apparatus is transparent to allow viewing of the workings of the apparatus
